(19) United States
(12) Patent Application Publication
(10) Pub. No.: US 2021/0372000 A1
(43) Pub. Date: Dec. 2, 2021

(54) METALLIZATION INHIBITOR FOR RACKS EMPLOYED IN GALVANIC TREATMENTS

(71) Applicant: MONTALDI S.R.L., Leinì (Torino) (IT)

(72) Inventor: Davide DEMICHELIS, Leinì (Torino) (IT)

(73) Assignee: MONTALDI S.R.L., Leinì (Torino) (IT)

(21) Appl. No.: 17/290,892

(22) PCT Filed: Oct. 29, 2019
(86) PCT No.: PCT/IB2019/059265

§ 371 Date: May 3, 2021

(30) Foreign Application Priority Data
Nov. 8, 2018 (IT) 102018000010168

(51) Int. Cl. C25D 17/08; B05D 1/18; C25D 5/56; B05D 7/14

(52) U.S. Cl. CPC C25D 17/08; B05D 1/18; B05D 2506/25; B05D 7/14; B05D 2320/00; C25D 5/56

(57) ABSTRACT

The metallization of a metallic rack employed in galvanic metallization processes of plastic material items, coated by immersion in PVC Plastisol, is inhibited thanks to the fact that PVC Plastisol is mixed with a C8-C18 thiol selected from octyl mercaptan, nonyl mercaptan, decyl mercaptan, n-octadecyl-3-mercaptopropionate, isooctyl-3-mercaptopropionate, n-octyl-mercaptopropionate, dodecyl-3-mercaptopropionate, tridecyl-3-mercaptopropionate, palmityl mercaptan, bis-phenyl-1,4-thiol.

### FIELD OF THE INVENTION

The present invention generally relates to the galvanic metallization of plastic material details.

In automotive, electrical appliance, lighting technique, taps and fittings fields and other industrial applications, components of plastic material are subjected to a chemical metallization treatment in a galvanic plant, through which one or more layers of metals (for example, copper, nickel and chromium) are deposited by an electrolytic process on plastic material details.

In these processes the details are hooked to equipment consisting of metallic frames (“racks”) which are then immersed in the galvanic baths. To avoid that the entire frame is also metallized together with the items subjected to metallization, it must be electrically and chemically isolated, typically by coating it with PVC Plastisol. For this purpose, the metallic frames are immersed in a dispersion of polyvinyl chloride in a plasticizer so as to be completely coated and therefore electrically isolated.

In galvanic processes for chrome plating, the current environmental and safety regulations are progressively banning the use of highly carcinogenic hexavalent chromium. For this reason, the electrolytic chromium (VI) (hexavalent) traditionally used in chrome plating has been progressively replaced by chrome (III) (trivalent). However, chromium (VI) is still used in mordanting (“etching”), which consists in immerging the plastic material detail, to be chromed, hooked to the frame in a chromic and sulphuric acid bath containing chromium (VI). This process allows the formation of a diffused network of superficial microcavities of the plastic material detail for the subsequent metallization steps and has the advantage of attacking the PVC Plastisol by which the frame is coated, contaminating it with chromium (VI) so as to inhibit subsequent metallization. In this regard, U.S. Pat. No. 3,939,056 describes a frame suitable for supporting non-electrically conductive materials during a galvanic treatment process, the surface of which is coated by a plastic resin in which at least one organosulphur compound is dispersed, which prevents its metallization during the galvanic treatment of the supported materials. The mordanting (“etching”) step is carried out using a mordanting solution composed of chromic anhydride and sulphuric acid, in other words through the use of chromium (VI).

As a result of the replacement of chromium (VI), new chrome-free etching solutions were developed, typically composed by different manganese and permanganate salts. These products work, but they involve the problem of how to avoid that even PVC Plastisol that coats and insulates the frame is metallized together with the plastic details attached to it.

### STATE OF THE PRIOR ART

To solve this problem, a first proposal consists in treating the frame by immerging it in a solution containing an inhibitor, after its plasticization with PVC Plastisol. This proposal, described for example in EP-3228729A1 and WO2017/174470, consists in immersing the plasticized frame in a solution containing a sulphur derivative and at least one inorganic acid.

In the case of EP-3059277, the solution in which the plasticized frame is immersed includes sulphur and nitrogen compounds, and according to US-2016/0102403 sulphur-based compositions are applied on Plastisol of the plasticized frame by immersion, spraying, brushing etc.

A second solution consists in introducing metallization inhibitors directly into the PVC Plastisol formulation, in which the frame is immersed for its plasticization. Such a solution is described for example in WO-2016/022535, according to which the metallization inhibitor comprises either of two classes of organosulphur compounds or thiols specifically consisting of tetrabenzyl thiuram disulphide and tetraphenyl thiuram disulphide.

This solution has proved inefficient in practice.

### SUMMARY OF THE INVENTION

The object of the present invention is to solve the aforementioned technical problem in a completely effective way, thanks to a specific selection of a sulphur-based inhibitor directly inserted in the PVC Plastisol formulation used for the plasticization of the electroplating frames.

According to the invention, this object is achieved thanks to the fact that this inhibitor belongs to the thiol family, in the C8-C18 carbon category, which comprises but is not limited to the following compounds:

octyl mercaptan

nonyl mercaptan

decyl mercaptan

n-octadecyl-3-mercaptopropionate

isooctyl-3-mercaptopropionate,

n-octyl-mercaptopropionate,

dodecyl-3-mercaptopropionate,

tridecyl-3-mercaptopropionate,

palmityl mercaptan,

bis-phenyl-1,4-thiol.

Experimental tests carried out by the Applicant have surprisingly shown that by such specific sulphur-based inhibitors directly mixed in PVC plastisol, the electroplating frames so plasticized are, absolutely effectively, metallization-free in the use, without having to proceed with any further treatment operation of the already plasticized frames and, particularly, using chrome (VI)-free etching solutions.

It should be noted that the use of thiols as identified above as metallization inhibitors was already foreseen, within the group of sulphur-based compounds, in the aforementioned document US-2016/0102403, but subsequently applied on the PVC plastisol of the already plasticized frame. The inventive and not obvious intuition of the inventor was to put this molecule in the PVC Plastisol solution in which the frame is immersed to be plasticized.

### DETAILED DESCRIPTION OF THE INVENTION

In accordance with the invention, the metallic frames used for metallization treatments and galvanic etching of plastic material items are in turn inhibited from metallization through their plasticization by immersion in a PVC Plastisol containing from 0.1% to 5% by weight of a C8-C18 thiol as identified above.

Preferably, the amount of thiol is between 0.5 and 5% and more preferably between 1 and 5%, and more conveniently the thiol consists in n-octadecyl-3-mercaptopropionate.

The composition thus obtained can further include, in the generic formulation of the PVC plastisol used for the plasticization of galvanic frames, the following components:
Plasticizers 25-40% by weight: acetyl tributyl citrate ATBC, di octyl adipate DOA, di iso-nonyl phthalate DINP, Alkylsulphonic phenyl ester MESAMOLL, epoxidized soybean oil ESBO
PVC resin: 45-60% by weight (Polyvinyl chloride emulsion and/or microsuspension K70-K80)
MINERAL FILLERS: 2-5% by weight (Calcium Carbonate, Calcium Oxide)
THICKENERS 1-5% by weight (Pyrogenic Silica, Calcium Sulphonate)
STABILIZERS 1-5% by weight (Calcium/Zinc Complex Salt)

The frames coated in this way completely effectively inhibit their metallization during the electroplating processes also, and particularly, with etching solutions free of carcinogenic substances such as chromium (VI).

The following examples are provided in a purely indicative and not limitative way.

### EXAMPLE 1 (COMPARATIVE)

### Metallization of Frame Coated by PVC Plastisol, Treated by a Chromium (VI)-Free Mn (III)-Based Etching Solution

A chromoplating frame coated by a PVC plastisol coating with an ABS test panel hooked was immersed in a cleaning solution then in a mordanting (“etching”) solution based on Manganese (III) ions at a temperature of 40° C.

Subsequently, the frame was subjected to the process of galvanic electrodeposition of the metallic coating (rinsing in water, activation of the surface by palladium solution, chemically-obtained deposition of a thin layer of metal, electrodeposition of metals on the metallized plastic material substrate)

At the end of the treatment there was a complete coating of the ABS panel but also of more than 80% of the frame. The solution used for etching did not inhibit the metallic coating of the frame.

### EXAMPLE 2 (COMPARATIVE)

### Metallization of Frame Coated by PVC Plastisol, Treated by a Chromium (VI)-Free Permanganate-Based Etching Solution

A chromoplating frame coated by a PVC plastisol coating with an ABS test panel hooked was immersed in a cleaning solution then in a mordanting (“etching”) solution based on Permanganate and sulphuric acid at a temperature of 65° C.

Subsequently, the frame was subjected to the same galvanic electrodeposition process described in the comparative example 1.

At the end of the treatment there was a complete coating of the ABS panel but also of more than 50% of the frame. Also in this case the solution used for the etching did not inhibit the metallic coating of the frame.

### EXAMPLE 3 (COMPARATIVE)

### Metallization of Frame Coated by PVC Plastisol with Addition of XyleneThiol Inhibitor, Treated by a Chromium (VI)-Free Mn (III)-Based Etching Solution

A PVC plastisol was prepared with the addition of 3% by weight (5% to the resin) of XyleneThiol as a metallization inhibitor. This modified plastisol was used to coat a chromoplating frame with an ABS test panel hooked, which was then subjected to the same process used in the comparative example 1.

At the end of the treatment there was a complete coating of the ABS panel but also of more than 70% of the frame. The solution used for etching and the PVC coating modified in this way did not inhibit the metallic coating of the frame.

### EXAMPLE 4 (COMPARATIVE)

### Metallization of Frame Coated by PVC Plastisol with Addition of XyleneThiol Inhibitor, Treated by a Chromium (VI)-Free Permanganate-Based Etching Solution

A PVC plastisol was prepared with the addition of 3% by weight (5% to the resin) of XyleneThiol as a metallization inhibitor. This modified plastisol was used to coat a chromoplating frame with an ABS test panel hooked, which was then subjected to the same process used in the comparative example 2.

At the end of the treatment there was a complete coating of the ABS panel but also of more than 60% of the frame. Also in this case the solution used for etching and the PVC coating modified in this way did not inhibit the metallic coating of the frame.

### EXAMPLE 5

### Use of a Frame Coated by PVC Plastisol with the Addition of an Inhibitor Treated by a Chromium (VI)-Free Mn (III)-Based Etching Solution

A PVC plastisol was prepared with the addition of 3% by weight of dodecyl-3-mercaptopropionate as a metallization inhibitor. This modified plastisol was used to coat a chromoplating frame with an ABS test panel hooked, which was then subjected to the same process used in the comparative example 1.

In this case there was no metallic coating on the frame, while the ABS panel was completely coated.

This test was repeated 10 times changing only the ABS panel and all the tests confirmed the positive results.

### EXAMPLE 6

### Use of a Frame Coated by PVC Plastisol with the Addition of an Inhibitor Treated by a Chromium (VI)-Free Mn (III)-Based Etching Solution

A PVC plastisol was prepared with the addition of 2% by weight of n-octadecyl-3-mercaptopropionate as a metallization inhibitor. This modified plastisol was used to coat a chromoplating frame with an ABS test panel hooked, which was then subjected to the same process used in the comparative example 1.

In this case there was no metallic coating on the frame, while the ABS panel was completely coated.

This test was repeated 20 times changing only the ABS panel and all the tests confirmed the positive results.

### EXAMPLE 7

### Use of a Frame Coated by PVC Plastisol with the Addition of an Inhibitor Treated by a Chromium (VI)-Free Permanganate-Based Etching Solution

A PVC plastisol was prepared with the addition of 2% by weight of n-octadecyl-3-mercaptopropionate as a metallization inhibitor. This modified plastisol was used to coat a chromoplating frame with an ABS test panel hooked, which was then subjected to the same process used in the comparative example 2.

In this case there was no metallic coating on the frame, while the ABS panel was completely coated.

This test was repeated 20 times changing only the ABS panel and all the tests confirmed the positive results.

1. A method for inhibiting metallization of a metallic rack employed in galvanic metallization processes of plastic material items, wherein the rack designed to bear the plastic material item is coated by immersion in PVC Plastisol, wherein the PVC Plastisol is mixed with a C8-C18 thiol selected from octyl mercaptan, nonyl mercaptan, decyl mercaptan, n-octadecyl-3-mercaptopropionate, isooctyl-3-mercaptopropionate, n-octyl-mercaptopropionate, dodecyl-3-mercaptopropionate, tridecyl-3-mercaptopropionate, palmityl mercaptan, bis-phenyl-1,4-thiol, and wherein the metallic rack is treated by a chromium (VI)-free etching solution.

2. The method according to claim 1, wherein the amount of C8-C18 thiol is comprised between 0.1% and 5% by weight of PVC Plastisol.

3. A metallization inhibitor for metallic racks employed in galvanic metallization of plastic material items and coated by PVC Plastisol, wherein the inhibitor consists of a C8-C18 thiol selected from octyl mercaptan, nonyl mercaptan, decyl mercaptan, n-octadecyl-3-mercaptopropionate, isooctyl-3-mercaptopropionate, n-octyl-mercaptopropionate, dodecyl-3-mercaptopropionate, tridecyl-3-mercaptopropionate, palmityl mercaptan, bis-phenyl-1,4-thiol mixed with PVC Plastisol before racks coating.

4. The metallization inhibitor according to claim 3, wherein the thiol is n octadecyl-3-mercaptopropionate in an amount comprised between 0.5 and 5% by weight of PVC Plastisol.

5. The metallization inhibitor according to claim 3, wherein the thiol is dodecyl-3-mercaptopropionate in an amount comprised between 0.5 and 5% by weight of PVC Plastisol.

6. A metallic rack coated by PVC Plastisol and employed in galvanic metallization processes of plastic material items, whose metallization is inhibited by the method according to claim 1.

7. A metallic rack coated by PVC Plastisol mixed with a metallization inhibitor according to claim 3.

8. The metallization inhibitor of claim 3 wherein the thiol is n-octadecyl-3-mercaptopropionate in an amount comprised between 1 and 5% by weight of PVC Plastisol.

9. The metallization inhibitor according to claim 3, wherein the thiol is dodecyl-3-mercaptopropionate in an amount comprised between 1 and 5% by weight of PVC Plastisol.
